(19) United States
(12) Patent Application Publication
(10) Pub. No.: US 2025/0264828 A1
(43) Pub. Date: Aug. 21, 2025

(54) DEVELOPING DEVICE

(71) Applicant: CANON KABUSHIKI KAISHA, Tokyo (JP)

(72) Inventor: Koji Shigehiro, Tokyo (JP)

(21) Appl. No.: 19/039,991

(22) Filed: Jan. 29, 2025

(30) Foreign Application Priority Data
Feb. 21, 2024 (JP) 2024-024892
Jan. 10, 2025 (JP) 2025-003864

(51) Int. Cl. G03G 15/09

(52) U.S. Cl. CPC G03G 15/0928

(57) ABSTRACT

A developing device includes a developing container, first and second rotatable developing members, a first magnet provided inside the first rotatable developing member, and a second magnet provided inside the second rotatable developing member. A rotational axis of the second rotatable developing member is positioned above a rotational axis of the first rotatable developing member. The developer is delivered from the first rotatable developing member to the second rotatable developing member against a gravitational direction by a magnetic field generated between the first magnet and the second magnet. On an outer peripheral surface of the first rotatable developing member, a plurality of first grooves are formed along a circumferential direction of the first rotatable developing member. On an outer peripheral surface of the second rotatable developing member, a plurality of second groves are formed along a circumferential direction of the second rotatable developing member.

### FIELD OF THE INVENTION AND RELATED ART

The present invention relates to a developing device for developing an electrostatic latent image, formed on an image bearing member, with a developer.

As the developing device, a constitution in which a developer is supplied from a plurality of developing sleeves to the electrostatic latent image formed on the image bearing member is known (United States Patent Application Publication No. 2011/0299892). Further, a constitution in which a plurality of grooves are provided on each of surfaces of a first developing sleeve and a second developing sleeve which supply the developer to the electrostatic latent image is proposed (Japanese Laid-Open Patent Application (JP-A) No. 2010-217237). In the constitution disclosed in JP-A 2010-217237, the first developing sleeve is positioned above the second developing sleeve in a vertical direction, and delivery of the developer from the first developing sleeve to the second developing sleeve is performed along a gravitational direction.

Here, in a region in which high-speed and high productivity are required as in production printing, in order to satisfy a stable image density, a developer feeding performance of the plurality of developing sleeves is required to be feeding capacity of a certain level or more. When the feeding capacity is insufficient, the developer cannot be delivered between the plurality of developing sleeves, so that there is a liability that the developer is dragged on the developing sleeve. The drag of the developer is a phenomenon such that the developer carried on the developing sleeve cannot be peeled off in a peeling region in which the developer is peeled off from the developing sleeve and is fed on the developing sleeve or a phenomenon such that the developer cannot be delivered between the plurality of developing sleeves and is fed on the developing sleeve, which is the developing sleeve from which the developer is to be delivered, as it is.

When the drag phenomenon occurs, a decrease in TD ratio (a weight ratio of a weight of toner to a total weight of a carrier and the toner) of the developer subjected to a developing step has the influence on a distribution of the TD ratio of the developer in a developing container, so that an image defect such as a fluctuation in color tint of a toner image occurs in a subsequent image forming step.

Particularly, different from JP-A 2010-217237, in a constitution in which delivery of the developer from the first developing sleeve to the second developing sleeve is made against the gravitational direction, the influence of the developer feeding capacity at the developing sleeve surface on the drag is large.

### SUMMARY OF THE INVENTION

A principal object of the present invention is to suppress an occurrence of an image defect.

According to an aspect of the present invention, there is provided a developing device comprising: a developing container configured to contain a developer including toner and carrier; a first rotatable developing member to which the developer contained in the developing container is supplied and which carries and feeds the developer to a first developing position where an electrostatic latent image formed on an image bearing member is developed; a second rotatable developing member provided opposed to the first rotatable developing member and to which the developer is delivered from the first rotatable developing member, wherein the second rotatable developer member carries and feeds the developer to a second developing position where the electrostatic latent image passed through the first developing position is developed; a first magnet provided non-rotatably and stationarily inside the first rotatable developing member; and a second magnet provided non-rotatably and stationarily inside the second rotatable developing member, wherein a rotational axis of the second rotatable developing member is positioned above a rotational axis of the first rotatable developing member, wherein the developer is delivered from the first rotatable developing member to the second rotatable developing member against a gravitational direction by a magnetic field generated between the first magnet and the second magnet, wherein on an outer peripheral surface of the first rotatable developing member, a plurality of first grooves are formed along a circumferential direction of the first rotatable developing member, and wherein on an outer peripheral surface of the second rotatable developing member, a plurality of second groves are formed along a circumferential direction of the second rotatable developing member.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to a first embodiment.

FIG. 2 is a schematic sectional view of a developing device according to the first embodiment.

FIG. 3 is a schematic view for illustrating a groove ratio in the first embodiment.

FIG. 4 is a table showing a verification result of a constitution in the first embodiment.

Part (a) of FIG. 5 is graph for illustrating a relationship between a developer carrying amount and a groove ratio in the constitution in the first embodiment, and Part (b) of FIG. 5 is graph for illustrating a relationship between a developer carrying amount and a peripheral speed of a developing sleeve in the constitution in the first embodiment.

FIG. 6 is a graph for illustrating groove pitch unevenness in a second embodiment.

FIG. 7 is a graph showing a verification result of a constitution according to the second embodiment.

FIG. 8 is a graph showing a verification result of a constitution according to a third embodiment.

### DESCRIPTION OF THE EMBODIMENTS

### First Embodiment

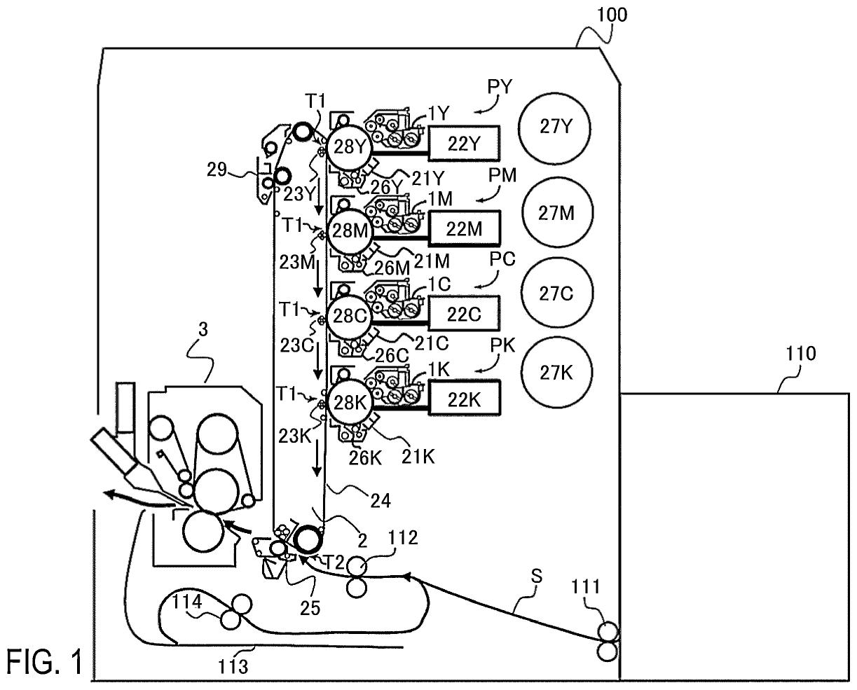

A first embodiment will be described using FIGS. 1 to 5. First, a general structure of an image forming apparatus in this embodiment will be described with reference to FIG. 1.

### [Image Forming Apparatus]

An image forming apparatus 100 is a full-color image forming apparatus, and in the case of this embodiment, the image forming apparatus 100 is, for example, an MFP (multi-function peripheral) having a copy function, a printer function, and a scan function. The image forming apparatus 100 includes, as shown in FIG. 1, image forming portions PY, PM, PC, and PK for performing an image forming step of forming toner images of four colors of yellow, magenta, cyan, and black, respectively, which are juxtaposed. For the image forming apparatus 100, an original reading device is connected to an image forming apparatus main assembly (apparatus main assembly) or a host device such as a host computer is communicatably connected to the apparatus main assembly. Accordingly, in accordance with image information from the host device, a four-color-based full-color image of yellow (Y), magenta (M), cyan (C), and black (K) can be formed on a recording material (recording sheet, plastic sheet, cloth, and the like) by utilizing an electrophotographic type.

The image forming portions PY, PM, PC, and PK for the respective colors include primary chargers 21Y, 21M, 21C, and 21K, developing devices 1Y, 1M, 1C, and 1K, light writing portions (exposure devices) 22Y, 22M, 22C, and 22K, photosensitive drums 28Y, 28M, 28C, and 28K, and cleaning devices 26Y, 26M, 26C, and 26K, respectively. Further, the image forming apparatus 100 includes a transfer device 2 and a fixing device 3. Incidentally, structures of the image forming portions for the respective colors PY, PM, PC, and PK are similar to each other, and therefore, in the following, description will be made using the image forming portion PY as a representative.

The photosensitive drum 28Y as an image bearing member is a photosensitive member having a photosensitive layer formed of a resin such as polycarbonate, containing an organic photoconductor (OPC), and is constituted so as to be rotated at a predetermined speed. The primary charger 21Y includes a corona discharge pole disposed at a periphery of the photosensitive drum 28Y and electrically charges a surface of the photosensitive drum 28Y by generated ions.

In the light writing portion (exposure device) 22Y, a scanning optical device is assembled, and by exposing the charged photosensitive drum 28Y to light on the basis of image data, a potential of an exposed portion is lowered, so that a charge pattern (electrostatic latent image) corresponding to the image data is formed. The developing device 1Y develops the electrostatic latent image, formed on the photosensitive drum 28Y, by transferring a developer accommodated therein onto the photosensitive drum 28Y. The developer is prepared by mixing a carrier with toner of an associated color, and the electrostatic latent image is visualized (developed) with the toner.

The transfer device 2 includes primary transfer rollers 23Y, 23M, 23C, and 23K, an intermediary transfer belt 24, and a secondary transfer roller 25. The intermediary transfer belt 24 is wound around the primary transfer rollers 23Y, 23M, 23C, and 23K and a plurality of rollers, and is supported so as to be travelable.

The primary transfer rollers 23Y, 23M, 23C, and 23K as primary transfer members are disposed in a named order from above in FIG. 1 and correspond to the colors of Y (yellow), M (magenta), C (cyan), and K (black), respectively. The secondary transfer roller 25 is disposed outside the intermediary transfer belt 24 and is constituted so that the recording materials is capable of passing through between the secondary transfer roller 25 and the intermediary transfer belt 24.

The respective color toner images formed on the photosensitive drums 28Y, 28M, 28C, and 28K are transferred (primarily transferred) onto the intermediary transfer belt 24 by the action of a primary transfer bias applied to the primary transfer rollers 23Y, 23M, 23C, and 23K in primary transfer portions (primary transfer nips) T1 where the intermediary transfer belt 24 and the photosensitive drums 28Y, 28M, 28C, and 28K are in contact with each other. For example, during image formation of the four-color-based full-color image, in the order starting from the photosensitive drum 28Y, the toner images are transferred onto the intermediary transfer belt 24, so that a color toner image in which layers of yellow, magenta, cyan, and black are superposed is formed.

On the other hand, the recording material S accommodated in a cassette 110 as a recording material accommodating portion is fed toward the transfer device 2 through a pick-up roller 111 and a registration roller pair 112. The recording material S is fed to a secondary transfer portion (nip) T2 where the intermediary transfer belt 24 and the secondary transfer roller 25 as a secondary transfer member are in contact with each other, which being synchronized with the toner image on the intermediary transfer belt 24. Then, the toner image formed on the intermediary transfer belt 24 is secondarily transferred onto the recording material S by the action of a secondary transfer bias applied to the secondary transfer roller 25 in the secondary transfer portion T2. To the recording material S on which the toner image is transferred, pressure and heat are applied in the fixing device 3. By this, the toner on the recording material S is melted, so that the color image is fixed on the recording material S. Thereafter, the recording material S is discharged to an outside of the image forming apparatus 100.

Incidentally, in the case where the image formation is carried out on both (double) sides (surfaces) of the recording material S, the recording material S passed through the fixing device 3 is fed to a reverse feeding path 113, in which the recording material S is turned upside down and is fed to the registration roller pair 112 by a feeding roller pair 114, and in the secondary transfer portion T2, similarly as described above, the toner image is transferred onto a back surface (side) of the recording material S. Then, again, in the fixing device 3, the toner image is fixed on the back surface of the recording material S.

A deposited matter such as the toner remaining on the photosensitive drums 28Y, 28M, 28C, and 28K after the primary transfer step is collected by the cleaning devices 26Y, 26M, 26C, and 26K. By this, the photosensitive drums 28Y, 28M, 28C, and 28K prepare for a subsequent image forming step. Further, a deposited matter remaining on the intermediary transfer belt 24 after the secondary transfer step is removed by an intermediary transfer belt cleaner 29.

Incidentally, the image forming apparatus 100 in this embodiment is capable of forming a desired monochromatic (single color) image, such as a black image, or a multi-color image by using the image forming portion for a desired single color or some of the image forming portions for the four colors. Further, in FIG. 1, the constitution in which the image forming portions PY, PM, PC, and PK for the respective colors are disposed in a vertical direction is employed, but may also be disposed in any direction such as a horizontal direction or an oblique direction.

Further, in this embodiment, an outer diameter of each of the photosensitive drums 28Y, 28M, 28C, and 28K is for example 80 [mm], and the image forming operation is executed while rotating the photosensitive drums at a peripheral speed of 513 mm/sec.

Developer storage portions 27Y, 27M, 27C, and 27K are provided correspondingly to the developing devices 1Y, 1M, 1C, and 1K, respectively, and in which bottles accommodating developers corresponding to the colors of yellow, magenta, cyan, and black are exchangeably mounted in a named order from above, respectively. The developer storage portions 27Y, 27M, 27C, and 27K are constituted so that the developers are capable of being fed (supplied) therefrom to the developing devices 1Y, 1M, 1C, and 1K corresponding to the colors of the developers stored therein, respectively.

For example, a toner weight ratio of the developer accommodated in each bottle is 90 to 98%, and a toner weight ratio of the developer in each of the developing devices 1Y, 1M, 1C, and 1K is 5 to 11%. For that reason, when the toner is consumed by development in each of the developing devices 1Y, 1M, 1C, and 1K, the developer containing the toner in an amount corresponding to a consumption amount of the toner is supplied, so that the toner weight ratio of the developer in each of the developing devices 1Y, 1M, 1C, and 1K is maintained in a constant amount.

### [Developing Device]

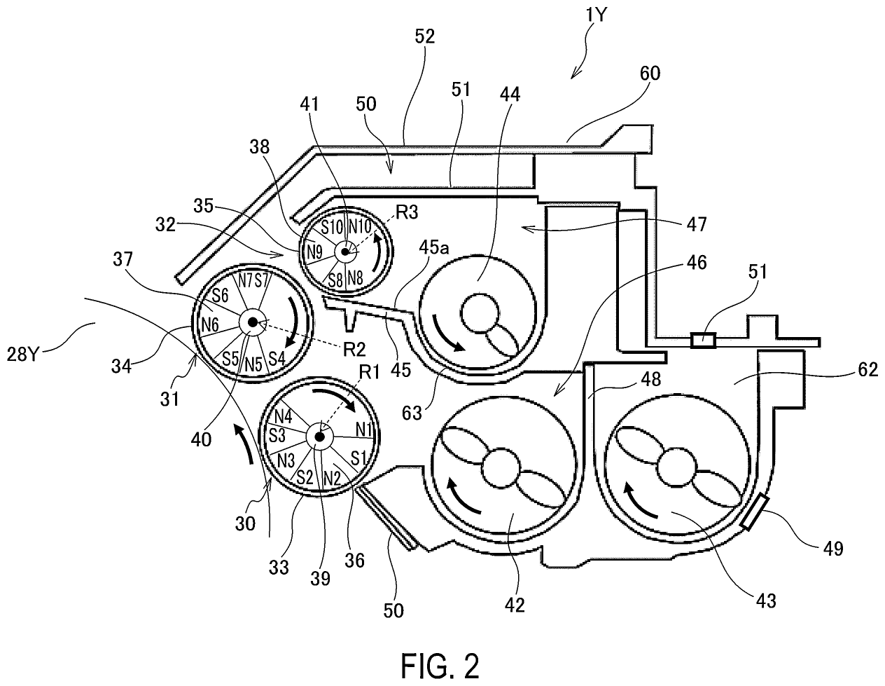

Next, the photosensitive drums 1Y, 1M, 1C, and 1K will be specifically described using FIG. 2. Incidentally, structures of the developing devices 1Y, 1M, 1C, and 1K are the same, and therefore, in the following, the developing device 1Y will be described as a representative. The developing device 1Y includes, as shown in FIG. 2, a first developing roller 30, a second developing roller 31, a peeling roller 32, a developer supplying screw 42, a developer stirring screw 43, and a developer collecting screw 44, and these members are accommodated in a developing container 60. The developing container 60 accommodates a two-component developer containing non-magnetic toner and a magnetic carrier.

The first developing roller 30 is a developer carrying member which is rotationally driven, and is provided in a position adjacent to the photosensitive drum 28Y so that a rotational axis thereof is substantially parallel to a rotational axis of the photosensitive drum 28Y. The first developing roller 30 includes a first developing sleeve 33 which is rotatable, and the first developing magnet (fixed magnet) 36 as a first magnet non-rotationally provided inside the first developing sleeve 33 and for attracting the developer to a surface of the first developing sleeve 33 by a magnetic force. Then, the first developing roller 30 (first developing sleeve 33) attracts (carries) the developer, scooped from the developer supplying screw 42 as a first developing sleeve screw, on the basis of the magnetic force, and develops the electrostatic latent image formed on the rotating photosensitive drum 28Y (image bearing member) at a first developing position, with the developer. That is, the first developing sleeve 33 carries and feeds the developer for developing the electrostatic latent image formed on the photosensitive drum 28Y.

The first developing sleeve 33 is a non-magnetic cylindrical member and is rotationally driven about a rotation shaft 39. A rotational direction of the first developing sleeve 33 is the clockwise direction as indicated by an arrow in FIG. 2 and is a direction opposite to a rotational direction of the photosensitive drum 28Y. For this reason, the first developing sleeve 33 and the photosensitive drum 28Y rotate in the same direction at mutually opposing positions (opposing portion). That is, the first developing sleeve 33 is rotated so that a surface thereof opposing the photosensitive drum 28Y moves from below toward above in a vertical direction.

The first developing magnet 36 is disposed inside the first developing sleeve 33 and includes, for example, as shown in FIG. 2, a plurality of magnetic poles as magnetic flux density peaks in a normal direction, and a non-magnetic pole portion. Between an inner periphery of the first developing sleeve 33 and an outer periphery of the first developing magnet 36, a space permitting rotation of the first developing sleeve 33 is provided.

The developer attracted onto the first developing sleeve 33 is coated in a thin layer on the surface of the first developing sleeve 33 by a magnetic field generated by a magnetic pole S1 of the first developing magnet 36 incorporated in the first developing roller 30 and by the action of a regulating member 50, with a rotating operation of the first developing sleeve 33. The developer coated in the thin layer on the first developing sleeve 33 is then fed toward the photosensitive drum 28Y so that the electrostatic latent image formed on the photosensitive drum 28Y is developed with the developer by a magnetic field generated by a first developing magnetic pole N3. After the electrostatic latent image formed on the photosensitive drum 28Y is developed with the developer, the developer on the first developing sleeve 33 is fed to the neighborhood of the second developing roller 31 by the rotating operation of the first developing sleeve 33. Then, in the neighborhood of a closest position between the first developing roller 30 and the second developing roller 31, the developer on the first developing sleeve 33 is peeled off from a surface of the first developing sleeve 33 and then delivered to a surface of a second developing sleeve 34 by a magnetic field generated by a delivering magnetic pole N4 of the first developing magnet 36 included in the first developing roller 30 and by a receiving magnetic pole S4 of the second developing magnet 37 included in the second developing roller 31. The receiving magnetic pole S4 of the second developing magnet 37 is in a different magnetic pole relationship from the delivering magnetic pole N4 of the first developing magnet 36.

The second developing roller 31 as a developing roller is a developer carrying member which is rotationally driven, and is provided downstream of the first developing roller 30 with respect to the rotational direction of the photosensitive drum 28Y. Further, the second developing roller 31 is disposed above a rotation center of the first developing roller 30 with respect to the vertical direction, and to the second developing roller 31, the developer is delivered from the first developing roller 30 by the magnetic force. The second developing roller 31 is, similarly as the first developing roller 30, disposed in a position adjacent to the photosensitive drum 28Y so that a rotational axis thereof is substantially parallel to the rotational axis of the photosensitive drum 28Y. Accordingly, the second developing roller 31 and the first developing roller 30 are substantially parallel to each other in rotational axis.

Such a second developing roller 31 includes the second developing sleeve 34 which is rotatable, and the second developing magnet (fixed magnet) 37 as a second magnet non-rotationally provided inside the second developing sleeve 34 and for attracting the developer to a surface of the second developing sleeve 34 by a magnetic force. A rotation center (a rotational axis) R2 of the second developing sleeve 34 is positioned above a rotation center (a rotational axis) R1 of the first developing sleeve 33 in the vertical direction. Further, to the second developing roller 31 (second developing sleeve 34), on the basis of the magnetic force, the developer is delivered from the first developing roller 30 (first developing sleeve 33). In this embodiment, delivery of the developer from the first developing sleeve 33 to the second developing sleeve 34 is performed against the gravitational direction. The second developing sleeve 34 attracts (carries) the developer delivered from the first developing sleeve 33, and develops the electrostatic latent image formed on the rotating photosensitive drum 28Y at a second developing position, with the developer. That is, the second developing sleeve 34 carries and feeds the developer for developing the electrostatic latent image formed on the photosensitive drum 28Y. Incidentally, on a side of the second developing roller 31, the peeling roller 32 described later is positioned.

The second developing sleeve 34 is a non-magnetic cylindrical member and is rotationally driven about a rotation shaft 40. A rotational direction of the second developing sleeve 34 is the clockwise direction as indicated by an arrow in FIG. 2 and is a direction opposite to the rotational direction of the photosensitive drum 28Y. For this reason, the second developing sleeve 34 and the photosensitive drum 28Y rotate in the same direction at mutually opposing positions. That is, the second developing sleeve 34 is rotated so that a surface thereof opposing the photosensitive drum 28Y moves from below toward above in the vertical direction. Further, the first developing sleeve 33 and the second developing sleeve 34 rotate in opposite directions at mutually opposing positions.

The second developing magnet 37 is disposed inside the second developing sleeve 34 and includes, for example, a plurality of magnetic poles as magnetic flux density peaks in the normal direction as shown in FIG. 2, and a non-magnetic pole portion. Between an inner periphery of the second developing sleeve 34 and an outer periphery of the second developing magnet 37, a space permitting rotation of the second developing sleeve 34 is provided.

The developer delivered from the delivering magnetic pole N4 of the first developing magnet 36 to the receiving magnetic pole S4 of the second developing magnet 37 and attracted onto the second developing sleeve 34 is fed toward the photosensitive drum 28Y by a rotating operation of the second developing sleeve 34, and develops the electrostatic latent image formed on the photosensitive drum 28Y, by a second developing magnetic pole 85. After the electrostatic latent image formed on the photosensitive drum 28Y is developed with the developer, the developer remaining on the second developing sleeve 34 is fed to the neighborhood of the peeling roller 32 by the rotating operation of the second developing sleeve 34. Then, in the neighborhood of a closest position between the second developing roller 31 and the peeling roller 32, the developer is delivered from the second developing sleeve 34 to a peeling sleeve 35 of the peeling roller 32 by a magnetic field generated between a delivering magnetic pole S7 of the second developing magnet 37 included in the second developing roller 31 and a receiving magnetic pole N9 of a peeling magnet 38 included in the peeling roller 32. The receiving magnetic pole N9 of the peeling magnet 38 and the delivering magnetic pole S7 of the second developing magnet 37 are in a different magnetic pole relationship.

Here, each of the delivering magnetic pole N4 of the first developing magnet 36 and the receiving magnetic pole S4 of the second developing magnet 37 is positioned on a photosensitive drum 28Y side than a rectilinear line passing through a rotation center R1 of the first developing sleeve 33 and a rotating center R2 of the second developing sleeve 34. In other words, the delivering magnetic pole N4 of the first developing magnet 36 may preferably be positioned on a side upstream of the opposing portion between the first developing sleeve 33 and the second developing sleeve 34 with respect to the rotational direction of the first developing sleeve 33. Further, the receiving magnetic pole S4 of the second developing magnet 37 may preferably be positioned on a side downstream of the opposing portion between the first developing sleeve 33 and the second developing sleeve 34 with respect to the rotational direction of the second developing sleeve 34. Further, in order to deliver the developer from the first developing sleeve 33 to the second developing sleeve 34 against the gravity, an absolute value of a magnetic flux density peak value of the developing magnet in the normal direction may preferably be larger at the receiving magnetic pole S4 of the second developing sleeve 34 than at the delivering magnetic pole N4 of the first developing sleeve 33.

The peeling roller 32 is provided on a side opposite from the photosensitive drum 28Y with respect to the rotation center R2 of the second developing sleeve 34 and peels off, from the second developing roller 31, the developer after the electrostatic latent image on the photosensitive drum 28Y is developed by the second developing roller 31. Specifically, the peeling roller 32 is a developer carrying member which is rotationally driven, and is provided between the second developing roller 31 and the developer collecting screw 44 so that a rotation center R3 thereof is positioned above the rotation center R2 of the second developing roller 31 in the vertical direction.

Further, the peeling roller 32 is disposed so that a rotational axis thereof is substantially parallel to a rotational axis of the second developing roller 31. Such a peeling roller 32 includes a peeling sleeve 35 which is rotatable, and the peeling magnet (fixed magnet) 38 non-rotationally provided inside the peeling sleeve 35 and for attracting the developer to a surface of the peeling sleeve 35 by a magnetic force, and is constituted so that the developer is delivered from the second developing roller 31 thereto on the basis of the magnetic force. That is, the peeling sleeve 35 is disposed opposed to the second developing sleeve 34 on a side with respect to the rotational direction of the second developing sleeve 34, downstream of a region where the second developing sleeve 34 opposes the photosensitive drum 28Y and upstream of a region where the second developing sleeve 34 opposes the first developing sleeve 33. Further, the peeling sleeve 35 peels off the developer, from the second developing sleeve 34, after developing the electrostatic latent image by the second developing sleeve 34 through a magnetic field generated by the second developing magnet 37, and then carries and feeds the developer.

The peeling sleeve 35 is a non-magnetic cylindrical member and is rotationally driven about a rotation shaft 41. A rotational direction of the peeling sleeve 35 is the counterclockwise direction as indicated by an arrow in FIG. 2, and is a direction opposite to the rotational direction of the second developing sleeve 34 in this embodiment. For this reason, the peeling sleeve 35 and the second developing sleeve 34 rotate in the same direction (forward direction) at mutually opposing positions (opposing portion).

The peeling magnet 38 is disposed inside the peeling sleeve 35 and includes, for example, a plurality of magnetic poles as magnetic flux density peaks in the normal direction as shown in FIG. 2, and a non-magnetic pole portion. Between an inner periphery of the peeling sleeve 35 and an outer periphery of the peeling magnet 38, a space permitting rotation of the peeling sleeve 35 is provided.

The developer attracted to the peeling sleeve 35 by the receiving magnetic pole N9 of the peeling magnet 38 included in the peeling roller 32 is fed to a downstream side of the rotational direction by a rotating operation of the peeling sleeve 35. The developer fed to the downstream side of the rotational direction is peeled off from the peeling sleeve 35 at a position close to the developer collecting screw 44 by the non-magnetic pole formed between the peeling magnetic pole N8 and a magnetic pole N10 of the peeling magnet 38 included in the peeling roller 32, so that the developer is dropped toward a guiding member 45 positioned below with respect to the vertical direction, by a self-weight thereof. Then, the developer dropped on the guiding member 45 is guided toward the developer collecting screw 44 by its own weight.

The guiding member 45 and the developer collecting screw 44 constitute a developer collecting portion 47 as a collecting portion for collecting the developer peeled off from the peeling sleeve 35 on the peeling roller 32. In the developer collecting portion 47, the developer collecting screw 44 is positioned below a rotation center of the peeling roller 32 in the vertical direction, and feeds the developer delivered (collected) from the peeling roller 32, while stirring the developer.

The guiding member 45 as a guiding portion is disposed below the rotation center of the peeling roller 32 with respect to the vertical direction, and guides the developer, peeled off by the peeling roller 32, toward the developer collecting screw 44. Such a guiding member 45 is provided with an inclined surface 45a along which the developer slides down by its own weight in order to reliably guide the peeled developer toward the developer collecting screw 44. The inclined surface 45a is inclined with respect to a horizontal direction so that a position thereof on the developer collecting screw 44 side is lower than a lower position of the peeling roller 32.

The developer collecting screw 44 as a collecting portion and a feeding portion feeds the collected developer to a developer circulating portion 46 described below. That is, the developer collecting screw 44 is a screw feeding member used for feeding the developer, collected by being slide down along the inclined surface 45a of the guiding member 45, in one direction while stirring the developer.

The developer circulating portion 46 is a supplying portion for supplying the developer to the first developing roller 30, and includes the regulating member 50, the developer supplying screw 42, and the developer stirring screw 43. In the developer circulating portion 46, the developer is supplied to the first developing roller 30 while the developer is fed in the substantially horizontal direction while being stirred in the developer supplying screw 42 and the developer stirring screw 43. Further, as described above, the developer collected by the developer collecting portion 47 is dropped by its own weight and is guided to the developer circulating portion 46. That is, the developer circulating portion 46 is positioned below the developer collecting portion 47 with respect to the vertical direction.

The developer supplying screw 42, the developer stirring screw 43, and the developer collecting screw 44 are screw feeding members for feeding the developer in one direction while stirring the developer, and the developer supplying screw 42 and the developer stirring screw 43 are positioned below a rotational center of the developer collecting screw 44 with respect to the vertical direction. Further, the developer supplying screw 42, the developer stirring screw 43, and the developer collecting screw 44 are disposed so that their rotational axes are substantially parallel to each other. The rotational axes of these screws are also substantially parallel to the rotational axis of the first developing roller 30.

The developer supplying screw 42 is positioned between the first developing roller 30 and the developer stirring screw 43, and between itself and the developer stirring screw 43, a partition wall 48 of the developing container 60 is provided. The partition wall 48 of the developing container 60 is extended along rotational axis directions of the developer supplying screw 42 and the developer stirring screw 43. The partition wall 48 is provided with a communication opening (not shown) for establishing communication between a first feeding path 61 along which the developer is fed by the developer supplying screw 42 and a second feeding path 62 along which the developer is fed by the developer stirring screw 43.

The developer stirred by the developer collecting screw 44 passes through a communication opening (not shown) formed in a partition wall 63 of the developing container 60 positioned between the developer collecting screw 44 and the developer supplying screw 42 and then is dropped toward the developer supplying screw 42 by its own weight. Incidentally, the above-described guiding member 45 is formed integrally with the partition wall 63, and above the partition wall 63, the developer collecting screw 44 is disposed.

A position of the communication opening through which the developer stirred by the developer collecting screw 44 is dropped by its own weight and is guided into the developer circulating portion 46 may preferably be disposed while avoiding a region (an intermediary portion with respect to the rotational axis direction of the developer supplying screw 42) in which the developer is supplied toward the first developing roller 30. In this embodiment, the position of the communication opening is a position where the communication opening position is included in a range of a downstream end portion (terminal portion) with respect to a developer feeding direction of the first feeding path 61 in which the developer supplying screw 42 is disposed.

Developer feeding directions of the developer supplying screw 42 and the developer stirring screw 43 are mutually opposite directions. Further, a starting end side (upstream end side in the developer feeding direction) and a terminal end side (downstream end side in the developer feeding direction) of the first feeding path 61 in which the developer supplying screw 42 is disposed, and a terminal end side and a starting end side of the second feeding path 62 in which the developer stirring screw 43 is disposed communicate with each other, respectively, via communication openings provided in the partition wall 48. Accordingly, the developer is circulated in the rotational directions of the developer supplying screw 42 and the developer stirring screw 43 indicated by arrows in FIG. 2 and in the substantially horizontal direction in the developing container 60, so that a part of the developer is supplied toward the first developing roller 30.

A developer supply opening 51 (see FIG. 2) is provided above the developer stirring screw 43 in the developing container 60 and is connected to the developer storage portion 27Y (see FIG. 1). Further, the developer supply opening 51 is constituted so as to be capable of supplying the developer, accommodated in a bottle mounted in the developer storage portion 27Y, to the second feeding path 62 in which the developer stirring screw 43 is disposed.

As described above, a toner weight ratio of the developer accommodated in the bottle of the developer storage portion 27Y is larger than a toner weight ratio of the developer in the developing device 1Y, and therefore, by adjusting an amount of the developer supplied to the developer stirring screw 43, the toner weight ratio of the developer in the developing device 1Y can be maintained at a certain level.

A toner concentration detecting sensor 49 (see FIG. 2) is provided for detecting a toner concentration of the developer contained in the developer circulating portion 46. The toner concentration detecting sensor 49 is a sensor for detecting (magnetic) permeability of the developer. The toner concentration corresponds to a consumption amount of the toner in the developing device 1Y, and therefore, is utilized in control of supply of the developer from the developer storage portion 27Y. For example, when it is detected that the toner concentration became lower than a predetermined value, the developer is supplied from the developer storage portion 27Y. Incidentally, the permeability of the developer changes depending on the toner concentration, and therefore, by utilizing the permeability, it is possible to detect the toner concentration.

The regulating member 50 is disposed adjacent to the first developing roller 30 and is used for regulating an amount of the developer supplied from the developer circulating portion 46 to the first developing roller 30. The regulating member 50 can be constituted so as to regulate an amount of the developer attracted to the first developing roller 30, on the basis of a gap between the surface of the first developing sleeve 33 of the first developing roller 30 and an end portion of the regulating member 50.

A circulating path of the developer in the developing container 60 is such that the developer is fed in the substantially horizontal direction while being stirred in the developer circulating portion 46 and thereafter is supplied to the first developing roller 30, and then is delivered from the first developing roller 30 to the second developing roller 31 positioned above the first developing roller 30, on the basis of the magnetic force. Then, the developer is delivered from the second developing roller 31 to the peeling roller 32 positioned beside the second developing roller 31, on the basis of the magnetic force again, and thereafter, is peeled off from the peeling roller 32 by the peeling magnet 38 included in the peeling roller 32, and thereafter, the developer is collected by the developer collecting portion 47 and then is guided again into the developer circulating portion 46.

Further, as described above, in this embodiment, a two-component development type is used as a development type, and as the developer, a developer obtained by mixing non-magnetic toner having a negative charging property with a carrier having a magnetic property is used. The non-magnetic toner is toner obtained by containing a colorant, a wax component, and the like in a resin such as polyester or styrene-acrylic resin, by forming the mixture in powder through pulverization or polymerization, and then by adding fine powder of titanium oxide, silica, or the like to a surface of the powder. The magnetic carrier is a carrier obtained by coating a resin material on a surface layer of a core comprising resin particles obtained by kneading ferrite particles or magnetic powder. The toner concentration in the developer (a weight ratio of the toner to the developer) in an initial state is 8% in this embodiment.

In general, the two-component development type using the toner and the carrier has a feature such that stress exerted on the toner is less than stress exerted on the toner in a one-component development type using a one-component developer because the toner and the carrier are charged to predetermined polarities by subjecting the toner and the carrier to triboelectric contact. On the other hand, by long-term use, an amount of a contaminant (spent) deposited on the carrier surface increases, and therefore, toner charging capacity gradually lowers. As a result, problems of a fog and a toner scattering arise. Although it would be considered that an amount of the carrier accommodated in the developing device is increased in order to prolong a lifetime of the two-component developing device, this causes upsizing of the developing device, and therefore is not desirable.

In order to solve the above-described problems on the two-component developer, in this embodiment, an ACR (auto carrier refresh) type is employed. The ACR type is a type such that an increase in amount of a deteriorated developer is suppressed by not only supplying a fresh developer little by little from the developer storage portion 27Y into the developing device 1Y but also discharging the developer, deteriorated in charging performance, little by little through a discharge opening (not shown) of the developing device 1Y. By this, the deteriorated carrier in the developing device 1Y is replaced with a fresh carrier, so that the charging performance of the carrier in the developing device 1Y can be maintained at an approximately constant level.

In the thus-constituted developing device 1Y of this embodiment, the developer in the first feeding path 61 is supplied to the first developing sleeve 33 by the developer supplying screw 42, and the developer supplied to the first developing sleeve 33 forms a developer storing portion by being carried in a predetermined amount on the first developing sleeve 33 by a magnetic field generated by the first developing magnet 36. The two-component developer on the first developing sleeve 33 passes through the developer storing portion by rotation of the first developing sleeve 33 and is coated in a thin layer on the surface of the first developing sleeve 33 by the regulating member 50, and then is fed toward the developing region opposing the photosensitive drum 28Y. In the developing region, the developer on the first developing sleeve 33 is erected and thus forms the magnetic chains.

In the first developing region where the first developing sleeve 33 and the photosensitive drum 28Y oppose each other, by the developing bias applied to the first developing sleeve 33, the electrostatic latent image formed on the photosensitive drum 28Y is visualized. In this embodiment, as the developing bias applied to the first developing sleeve 33, a waveform in which both an AC electric field and a DC electric field are superimposed is applied, but a developing bias consisting only of the DC electric field may also be employed.

The two-component developer is delivered to the second developing sleeve 34 in a position close to the second developing sleeve 34 after being subjected to the developing step in the first developing region, and then is fed toward a second developing region where the second developing sleeve 34 and the photosensitive drum 28Y opposes each other. In the second developing region, a developing bias which is the same as the developing bias in the first developing region is applied and toner insufficient for a potential of the electrostatic latent image on the photosensitive drum 28Y is supplemented by development, and the toner image is uniformly adjusted by collecting the toner excessively used for developing the electrostatic latent image. Here, as regards the developing bias applied to the first developing sleeve 33 and the developing bias applied to the second developing sleeve 34, biases different in waveform may be applied.

Then, the developer which passed through the second developing region is peeled off in a peeling magnetic region formed by the second developing magnet 37 included in the second developing sleeve 34. The developer peel off from the second developing sleeve 34 is attracted to the surface of the peeling sleeve 35 by a magnetic field formed by the peeling magnet 38 included in the peeling sleeve 35 of the peeling roller 32, and then the developer is fed along the rotational direction of the peeling sleeve 35. Then, the developer is detached from the surface of the peeling sleeve 35 by a peeling magnetic field formed by the peeling magnet 38 and is collected to the developer collecting portion 47.

Here, in order to form a high-quality image by using the developing device having the above-described constitution, it is required that there is no deliver error when the developer is delivered from the first developing sleeve 33 to the second developing sleeve 34. When the deliver error occurs, the developer is dropped below in the vertical direction from a peeling region formed by the first developing magnet 36 of the first developing sleeve 33. Then, the developer is dropped into the neighborhood of the regulating member 50 and is not stirred in the developer circulation path, and is immediately supplied from the first feeding path 61 to the first developing sleeve 33. By this, the developer uneven in the amount is subjected to the developing step, so that a fluctuation in density occurs.

Further, in order to form the high-quality image by using the developing device 1Y, it is required that the developer can be delivered without being dragged between the developing sleeves. Unless the developer feeding capacity of each of the plurality of developing sleeves provided is sufficient, delivery of the developer between the developing sleeves is not made sufficiently, and thus the developer is dragged, so that there is a liability that the dragged developer is dropped onto the neighborhood of the regulating member 50 as described above.

The phenomenon as described above is liable to occur in a constitution in which an image forming speed (process speed) is high in a constitution in which the regulating member 50 is disposed at a lower portion where the developer is fed and particularly in which the developer fed upward via the plurality of developing sleeves against the gravity. For this reason, in such a constitution, particularly for each of the developing sleeves, appropriate developer feeding capacity is required. In this embodiment, the first developing sleeve 33 operates at a peripheral speed of 513 [mm/sec] which is the same as the peripheral speed of the photosensitive drum 28Y, and the second developing sleeve 34 operates at a peripheral speed of 616 [mm/sec].

### [Surface Configurations of First Developing Sleeve and Second Developing Sleeve]

Therefore, in this embodiment, the drag of the developer is suppressed by optimizing surface shapes (configurations) of the first developing sleeve 33 and the second developing sleeve 34. First, the surface shapes of the first developing sleeve 33 and the second developing sleeve 34 will be described.

In this embodiment, each of the surface of the first developing sleeve 33 and the surface of the second developing sleeve 34 is provided with a plurality of grooves formed so as to be arranged in a circumferential direction. That is, on an outer peripheral surface of the first developing sleeve 33, a plurality of first grooves are formed along a circumferential direction of the first developing sleeve 33, and on an outer peripheral surface of the second developing sleeve 34, a plurality of second grooves are formed along a circumferential direction of the second developing sleeve 34. The plurality of grooves are formed on the surface of each of the developing sleeves so as to be parallel to a longitudinal direction (rotational axis direction of developing sleeve). Further, in this embodiment, the plurality of grooves are formed by a cutting method. Further, in this embodiment, a shape of these grooves (hereinafter, this shape is also referred to as a “groove shape” is made a V-(character) shape in cross section perpendicular to the longitudinal direction. Incidentally, as regards the groove shape, shapes such that a cross-sectional shape perpendicular to the longitudinal direction is a U-(character) shape, a trapezoidal shape, or a shape with edges at a recessed-shaped corners may be used. Further, as a groove processing method, the method is not limited to the cutting method, but another processing method such as etching, pressing, or the like may be used.

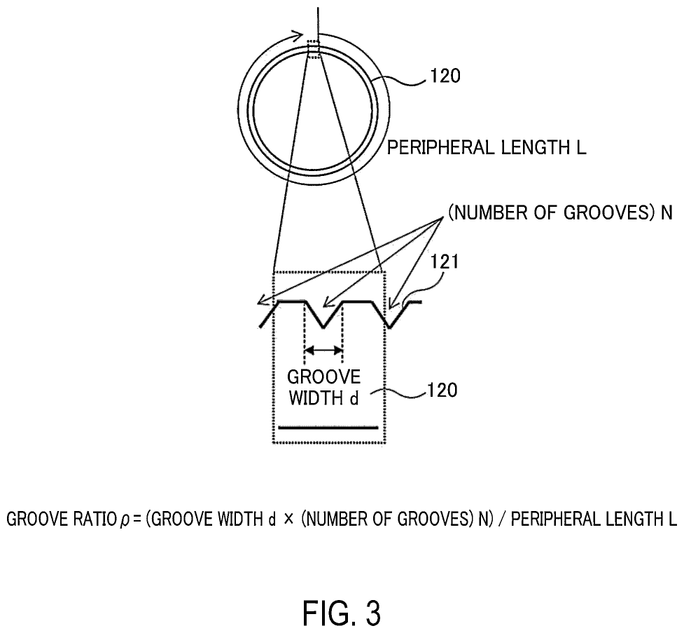

As an index relating to feeding capacity of the groove shape of the developing sleeve surface, a “groove ratio” is defined. A groove ratio ρ is defined by the following formula 1 as shown in FIG. 3 when the number of grooves 121 per one-full circumference of a certain developing sleeve 120 is N, a width per one groove 121 is d, and a peripheral length of the developing sleeve 120 is L.

$$ρ = ( d \times N ) / L \qquad ( formula 1 )$$

Specifically, in the case where a width of each of the first grooves of the first developing sleeve 33 is d1, a number of the first grooves per one-full circumference of the first developing sleeve 33 is N1, and a peripheral length of the first developing sleeve 33 is L1, a groove ratio ρ1 of the first grooves is ρ1=(d1×N1)/L1. Similarly, in the case where a width of each of the second grooves of the second developing sleeve 34 is d2, a number of the second grooves per one-full circumference of the second developing sleeve 34 is N2, and a peripheral length of the second developing sleeve 34 is L2, a groove ratio ρ2 of the second grooves is ρ2=(d2×N2)/L2.

At this time, when the groove ratio ρ is large, the developer feeding capacity becomes large, and when the groove ratio ρ is small, the developer feeding capacity becomes small. Further, the groove ratio ρ is a proportion of a groove width per one-full circumference of the developing sleeve 120, and therefore, irrespective of an outer diameter of the developing sleeve 120, the developer feeding capacity can be expressed uniquely. As a basic configuration, for example, a developing sleeve 120 of (outer diameter)=25 [mm], (groove width) d=0.144 [mm], (number of grooves) N=62 (grooves) is used, the groove ratio ρ becomes 11.4[%]. Although the groove ratio ρ varies depends on a physical property, flowability, or the like of the developer, but falls within a range of about 10[%] to 21[%] in many instances.

On the other hand, each of rotational speeds of the first developing sleeve 33 and the second developing sleeve 34 is also an index largely contributing to the developer feeding capacity, so that it is required that the developer feeding capacity is considered in combination with the above-described groove ratio ρ. In this embodiment, the plurality of developing sleeves opposing the same photosensitive drum 28Y is considered, and therefore, contribution of the first developing sleeve 33 and the second developing sleeve 34, as rotational speeds, to a developer feeding force can be expressed as a peripheral speed ratio (rate) of an associated developing sleeve to the photosensitive drum 28Y.

Here, a developer feeding force C of the developing sleeve is defined as shown by the following formula 2.

$$C = ρ \times rate\_v \qquad ( formula 2 )$$

Here, rate_v is the peripheral speed ratio of the developing sleeve to the photosensitive drum 28Y. Further, the plurality of developing sleeves contacting the single photosensitive drum 28Y are used, and therefore, the peripheral speed ratio is employed, but even when the feeding force is calculated, there is no problem.

When the groove ratio ρ is large, capacity such that the developing sleeve surface holds (grips) the developer becomes high, so that capacity such that magnetic chains of the developer follow rotation of the developing sleeve becomes high. For that reason, even in the case where the developer is coated in thin layer on the developing sleeve by the regulating member 50, when the groove ratio ρ is large, a developer amount M/S per unit area after formation of the thin layer becomes large.

Here, a developer feeding force of the first developing sleeve 33 is C1, a developer feeding force of the second developing sleeve 34 is C2, a groove ratio of the first developing sleeve is ρ1, a groove ratio of the second developing sleeve 34 is ρ2, a peripheral speed ratio of the first developing sleeve 33 is rate_v1, and a peripheral speed ratio of the second developing sleeve 34 is rate_v2, a feeding force C1 of the first developing sleeve 33 and a feeding force C2 of the second developing sleeve 34 are shown by the following formulas 3 and 4, respectively.

$$C 1 = ρ1 \times rate\_v1 \qquad ( formula 3 )$$

$$C 2 = ρ2 \times rate\_v2 \qquad ( formula 4 )$$

Further, in the case where the image is formed on the photosensitive drum 28Y by using the plurality of developing sleeves, with respect to the rotational direction of the photosensitive drum 28Y, an upstream-side developing sleeve (first developing sleeve 33 in this embodiment) performs a function of ending an appropriate developing step, and a downstream-side developing sleeve (second developing sleeve 34 in this embodiment) performs a function of adjusting a non-uniform state of the toner layer causing an image defect such as a white void or enhancement of an edge. For that reason, between the first developing sleeve 33 and the second developing sleeve 34, in some instances, the peripheral speed ratio is changed. In the case where there is a problem on a thin density side such as the white void of the edge, the peripheral speed ratio of the second developing sleeve 34 is set so as to shifted toward a high side. On the other hand, in the case where there is a problem on a thick density side such as the edge enhancement, the peripheral speed ratio of the second developing sleeve 34 is set so as to be shifted toward a low side. In this embodiment, as a default setting of the peripheral speed ratio, the peripheral speed ratio rate_v1 of the first developing sleeve 33 is set to 1.0, and the peripheral speed ratio rate_v2 of the second developing sleeve 34 is set to 1.2.

Next, a result of verification of a developer drag phenomenon of the first developing sleeve 33 will be described. In this verification, the developing device 1Y and the photosensitive drum 28Y were fixed in a positional relationship similarly as in the apparatus main assembly and were installed in a jig capable of drivably carrying these members. Then, the developer drag phenomenon of the first developing sleeve 33 was verified. Further, a high-voltage power source was connected to each of the photosensitive drum 28Y and the first developing sleeve 33, so that the developing step was made possible.

Setting was made so that analog development was performed by applying a DC bias superposed on an AC bias formed by a blank pulse responding to one waveform per two waveforms under a condition that a surface potential of the photosensitive drum 28Y is 0 [V], a peak-to-peak voltage of the first developing sleeve 33 is 1.4 [kV], and a frequency of 11 [KHz]. As regards the DC bias, printing of the image on an A3-size sheet was assumed, an operation similar to actual printing was reproduced by switching the DC bias between a DC bias of −150 [V] in a period of 813 [msec] which is an image region and a DC bias of +150 [V] in a period of 187 [msec] in which a sheet interval is assumed. Incidentally, the sheet interval is an interval between a plurality of recording materials successively fed to the secondary transfer portion, and in this verification, the sheet interval in the case where A3-size sheets are successively fed to the secondary transfer portion was assumed. Further, to the photosensitive drum 28Y, a blade made of urethane was contacted and provided so as to remove the toner deposited on the surface of the photosensitive drum 28Y, and was made capable of collecting the toner subjected to the development and thus was made continuously operable.

By using the above-described verification constitution, for the drag of the developer on the first developing sleeve 33, a state of the drag was observed by providing a small video camera (manufactured by ENABLE, INC.) in an opposing position of a gap between the first developing sleeve 33 and the second developing sleeve 34 on a developing container side.

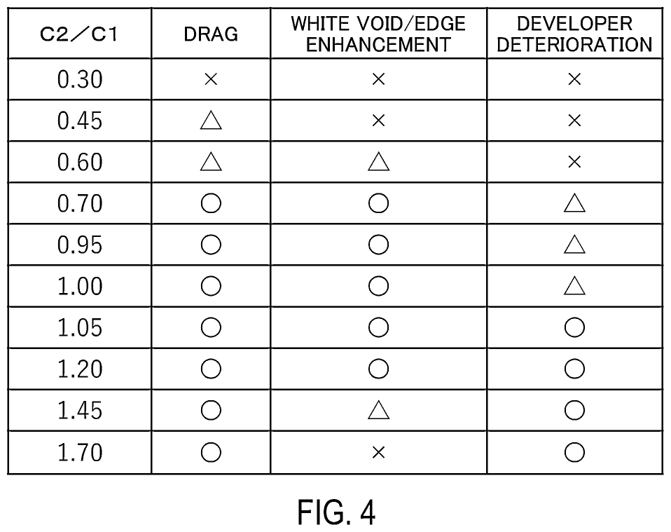

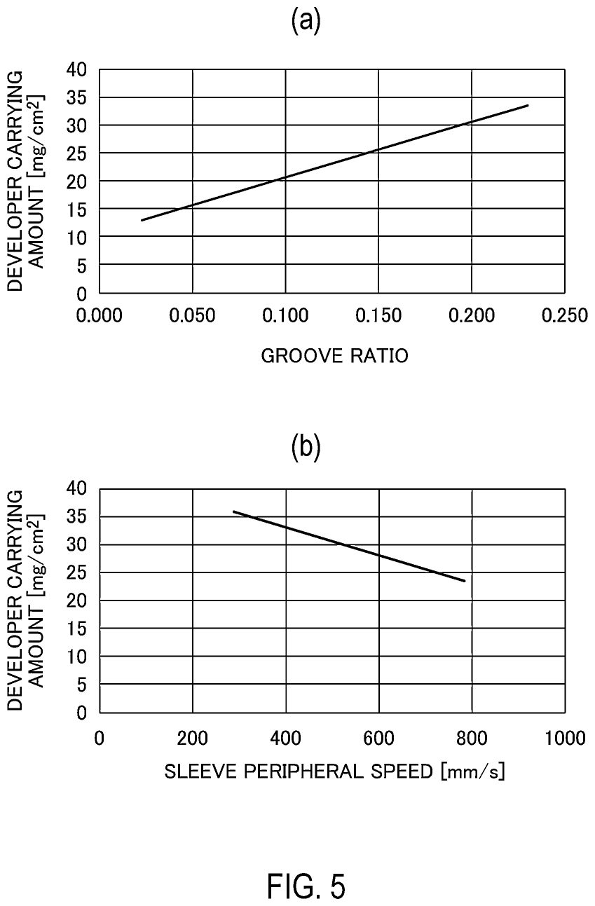

In the above-described constitution, with respect to C2/C1 which is a relationship between the feeding force C1 of the first developing sleeve 33 and the feeding force C2 of the second developing sleeve 34, a result of verification of occurrence or non-occurrence of the drag phenomenon on the first developing sleeve 33 is shown in FIG. 4. In a column of “DRAG” in FIG. 4, “◯” represents that the drag phenomenon substantially did not occur, “Δ” represents that the drag phenomenon somewhat occurred, and “x” represents that the drag phenomenon occurred. Further, in a column of “WHITE VOID/EDGE ENHANCEMENT” in FIG. 4, “◯” represents that the edge white void/enhancement substantially did not occur, “Δ” represents that the edge white void/enhancement somewhat occurred, and “x” represents that the edge white void/enhancement occurred.

As shown in FIG. 4, when a relationship of a ratio C2/C1 between the feeding forces C1 and C2 calculated from the peripheral speed ratios rate_v1 and rate_v2 and the groove ratios ρ1 and ρ2 by using the above-described formulas 3 and 4 satisfies:

C2/C1≥0.70,

it becomes possible to sufficiently deliver the developer from the first developing sleeve 33 to the second developing sleeve 34, so that it was confirmed that the drag phenomenon did not readily occur on the first developing sleeve 33 in the above-described constitution. In this embodiment, as described above, the peripheral speed ratio rate_v1 of the first developing sleeve 33 is 1.0 and the peripheral speed ratio rate_v2 of the second developing sleeve 34 is 1.2, and therefore, a combination of the groove ratios ρ1 and ρ2 providing the ratio C2/C1 (of the feeding forces C1 and C2) of 0.7 is the groove ratio ρ1 of 19.8[%] and the groove ratio ρ2 of 11.6[%].

On the other hand, when the feeding force ratio C2/C1 becomes less than 0.6 further smaller than 0.7, in addition to the drag, the white void in a boundary portion of light and shade in latent image step becomes liable to appear, with the result that the influence thereof on the image was large. This is because an effect such that in the developing step, the second developing sleeve 34 adjust toner layer potential non-uniformity after development by the first developing sleeve 33 relative to a latent image potential on the photosensitive drum 28& is decreased.

Further, it turned out that a margin can be sufficiently taken against the drag and the white void image by satisfy:

C2/C1≥0.95,

which is a condition such that the feeding force of the second developing sleeve 34 is high with respect to the feeding force ratio C2/C1 of 0.7.

Thus, the feeding force C2 of the second developing sleeve 34 may preferably be equal to or more than the feeding force C1 of the first developing sleeve 33, and as wave preferable condition, C2/C1>1 is satisfied.

In this case, the developer is delivered from the first developing magnet 36 to the second developing magnet 37 against the gravity via opposing magnetic poles (the delivering magnetic pole N4 of the first developing magnet 36 and the receiving magnetic pole S4 of the second developing magnet 37), and therefore, in the case where the feeding force of the second developing sleeve 34 on the downstream side of the feeding direction is below the feeding force of the first developing sleeve 33 on the upstream side of the feeding direction, there is a tendency that an amount in which the developer stagnates in a delivering portion between the developing sleeves becomes large. In general, when the developer stagnation amount increases, a contact delivery area with the second developing sleeve 34 increases, so that a feeding amount is ensured. On the other hand, by this, there is a liability that a torque in the second developing sleeve 34 increases and thus a developer deterioration is accelerated, and in an extreme case, there is a liability that the developer flows back to the upstream side of the feeding direction of the developer by the first developing sleeve 33. In a constitution in which the above-described feeding force ratio C2/C1 is 0.7 or more, this condition is a condition under which an extremely harmful effect such as flowback of the developer does not occur.

Here, levels of the developer deterioration shown in the table of FIG. 4 will be described. The developer deterioration levels are obtained by measuring a charge amount of the developer when print images each with an image ratio of 10% are printed on 1000 K (1000 multiplied by 1000) sheets of recording materials, and were evaluated by a lowering amount of a toner charge amount from an initial stage. As regards the developer deterioration levels shown in the table of FIG. 4, the level at which the deterioration does not substantially occur is indicated by “◯”, the level at which the deterioration somewhat occurs but is an allowable level is indicated by “Δ”, and the level at which the deterioration occurs and is an unallowable level is indicated by “x”.

In the case where the feeding force ratio C2/C1 is 1.05 or more, as regards the toner charge amount due to use, lowering amounts thereof are substantially the same (developer deterioration level: “◯”). On the other hand, in the case where the feeding force ratio C2/C1 is 0.7 to 1.0, compared with the case where the feeding force ratio C2/C1 is 1.05 or more, the toner charge amount due to use lowers by about 3 to 5% (developer deterioration level: “Δ”). Further, in the case where the feeding force ratio C2/C1 is less than 0.7, compared with the case where the feeding force ratio C2/C1 is 1.05 or more, the toner charge amount due to use further lowers by 10% or more (developer deterioration level: “x”). for this, in order to reduce a degree of the developer deterioration or the like, by increasing the feeding force ratio C2/C1 than 1 as under the condition in this embodiment, the developer stagnation amount between the first developing sleeve 33 and the second developing sleeve 34 can be made an appropriate amount.

Here, for C1 and C2 as the feeding forces in the case where the feeding force ratio C2/C1 is larger than 1, a combination of a relationship between the peripheral speed ratio rate_v and the groove ratio ρ which are constituent elements thereof will be described.

The peripheral speed ratio rate_v is a ratio of a peripheral speed of the developing sleeve to a peripheral speed of the photosensitive drum 28Y and is a ratio of surface line speeds in an opposing portion of each of the first developing sleeve 33 and the second developing sleeve 34 to the photosensitive drum 28Y. For this reason, when the peripheral speed ratio rate_v is large, a developer feeding amount per unit time increases. Further, as regards the groove ratio ρ, a developer carrying amount per unit area becomes large as the groove ratio ρ becomes high, so that even when the developing sleeves are rotated at the same peripheral speed, the developer feeding amount per unit area becomes large. For this reason, even in the case where the developer is delivered from the first developing sleeve 33 to the second developing sleeve 34 against the gravity, the developer can be delivered between the first developing sleeve 33 and the second developing sleeve 34 without being stagnated.

Here, the feeding force ratio C2/C1 in the case where the peripheral speed ratios of the first developing sleeve 33 and the second developing sleeve 34 are the same and the groove ratios of the first developing sleeve 33 and the second developing sleeve 34 are different from each other will be considered.

For example, in the case where rate_v2=rate_v1 and ρ>ρ1 are satisfied, the feeding force is increased by increasing the developer carrying amount of the surface of the second developing sleeve 34. For this reason, even when the developer is delivered from the first developing sleeve 33 to the second developing sleeve 34 against the gravity, the developer can be delivered between the first developing sleeve 33 and the second developing sleeve 34 without being stagnated.

Further, for example, in the case where rate_v1=rate_v2=1.0 hold as the peripheral speed ratios rate_v of the first developing sleeve 33 and the second developing sleeve 34 and ρ1=11.6[%] and ρ2=14.6[%] hold as the groove ratios ρ of the first developing sleeve 33 and the second developing sleeve 34, a constitution of the feeding force ratio C2/C1≥1.0 can be satisfied.

In the constitution of this embodiment, as shown in part (a) of FIG. 5, a relationship in which when the groove ratio ρ changes by 1[%], the developer carrying amount on the sleeve (developer application amount when the developing sleeve is at rest) changes by 1[%] is established. For example, in the case where ρ1=11.6[%] and ρ2=14.6[%] hold as the groove ratios of the first developing sleeve 33 and the second developing sleeve 34, the second developing sleeve 34 is higher in groove ratio than the first developing sleeve 33 by 3[%], and therefore, the second developing sleeve 34 is larger in developer carrying amount than the first developing sleeve 33 by 3 [mg/cm²]. For this reason, a stable feeding state can be obtained between the first developing sleeve 33 and the second developing sleeve 34 without causing the stagnation of the developer.

Further, as shown in part (b) of FIG. 5, there is a tendency that the developer carrying amount on the sleeve (the developer application amount when the developing sleeve is at rest) lowers as the peripheral speed of the developing sleeve becomes fast in general. In an amount of the developer supplied by shearing when the developer is supplied to the developing sleeve, the developer is carried and fed while leaving a part of the developer. On the other hand, a shearing force acting on the developer carried and fed on the developing sleeve becomes larger as the peripheral speed of the developing sleeve becomes faster, so that the developer carrying amount on the developing sleeve lowers. On the other hand, as the peripheral speed of the developing sleeve becomes faster, the developer carrying amount per unit time of the developer passing through the opposing portion between the developing sleeve and the photosensitive drum 28Y becomes larger.

As is understood from part (b) of FIG. 5, for example, in the case where the peripheral speed of the developing sleeve is increased from 400 [mm/sec] to 600 [mm/sec] by 50%, the developer carrying amount is decreased from 33 [mg/cm²] by about 15%. For this reason, a relationship such that the developer carrying amount on the developing sleeve is decreased as the peripheral speed of the developing sleeve is made fast and thus the developer amount per unit time of the developer sent to the opposing portion between the developing sleeve and the photosensitive drum 28Y is increased is established. For example, in the case where rate_v2>rate_v1 and ρ2=ρ1 hold, the groove ratios of the first developing sleeve 33 and the second developing sleeve 34 are the same and the peripheral speed ratio of the second developing sleeve 34 is made larger than the peripheral speed ratio of the first developing sleeve 33. Thus, a constitution in which the developer feeding force of the second developing sleeve 34 is increased by making the peripheral speed ratio of the second developing sleeve 34 larger than the peripheral speed ratio of the first developing sleeve 33 and thus a feeding distance per unit time of the developer on the surface of the second developing sleeve 34 is made long is employed. Thus, the peripheral speed ratio of the second developing sleeve 34 is made larger than the peripheral speed ratio of the first developing sleeve 33 and thus the developer carrying amount of the developer on the second developing sleeve 34 is decreases, so that occurrence of the stagnation of the developer between the first developing sleeve 33 and the second developing sleeve 34 is suppressed.

Further, for example, a constitution in which C2/C1=1.2 can be satisfied by setting ρ1=ρ2=11.6[%], rate_v1=1.0, and rate_v2=1.2, with the result that a constitution of C2/C1>1.0 can be satisfied. As described above, in general, there is a tendency that the developer amount of the developer carried on the developing sleeve is decreased as the peripheral speed of the developing sleeve is made fast. In the case where the peripheral speed of the second developing sleeve 34 is made faster than the peripheral speed of the first developing sleeve 33 by 20[%], as shown in part (b) of FIG. 5, the developer carrying amount is decreased by about 6.7[%], but by increasing the peripheral speed of the developing sleeve, the feeding amount per unit time of the developer sent to the opposing portion between the developing sleeve and the photosensitive drum 28Y is substantially increased by about 13.3[%], so that the degree of the stagnation of the developer between the first developing sleeve 33 and the second developing sleeve 34 is reduced.

As a factor such that the drag is liable to occur when C2/C1 becomes less than 0.7, the following phenomenon would be considered. That is, the delivery of the developer from the first developing sleeve 33 to the second developing sleeve 34 is performed from below in the vertical direction against the gravity. For this reason, when the feeding force C1 of the first developing sleeve 33 is excessively larger than the feeding force C2 of the second developing sleeve 34, the developer is not sufficiently delivered from the first developing sleeve 33 to the second developing sleeve 34. As a result, the developer is dragged on the first developing sleeve 33, so that the developer is fed to a downstream side of the feeding direction of the first developing sleeve 33.

Thus, when the drag of the developer occurs, inside the developing container 60, the developer is peeled off from the first developing sleeve 33 and is dropped on the neighborhood of the regulating member 50. Then, the developer lowered in TD ratio by being subjected to the developing step by the first developing sleeve 33 is immediately supplied again to the first developing sleeve 33 without being stirred, so that a density fluctuation due to the toner density non-uniformity occurs.

On the other hand, when C2/C1 becomes excessively large, i.e., when the feeding force C2 of the second developing sleeve 34 becomes excessively larger than the feeding force C1 of the first developing sleeve 33, with respect to the rotational direction of the photosensitive drum 28Y, excessive supply of the toner to a downstream side of the latent image occurs, so that a downstream end portion of the latent image is excessively developed with the toner. As a result, an image defect such as the edge enhancement occurs. This image defect occurs in the case where the feeding step of the second developing sleeve 34 particularly on the downstream side of the latent image is excessively fast, i.e., in the case of rate_v2>>rate_v1, or in the case where the groove ratio ρ is excessively large and thus the developer amount of the developer carried on the second developing sleeve 34 is excessively large or under both conditions. Thus, even when the feeding force C2 of the second developing sleeve 34 is made excessively larger than the feeding force C1 of the first developing sleeve 33, an effect of adjusting a non-uniform state of the toner layer becomes small. When C2/C1 becomes 1.45 or more, although the drag does not roughly occur, the white void or the edge enhancement somewhat occurs.

For this reason, the ratio C2/C1 between the feeding forces of the first developing sleeve 33 and the second developing sleeve 34 may preferably satisfy:

$$0.7 \leq C 2 / C 1 < 1.45 .$$

Further, from a viewpoint of the above-described developer deterioration index, as a more preferable condition, the following relationship is satisfied:

$$1. < C 3 / C 2 < 1.45 .$$

Thus, in this embodiment, in a constitution in which the delivery of the developer from the first developing sleeve 33 to the second developing sleeve 34 is performed against the gravitational direction, the plurality of grooves 121 are arranged in the circumferential direction on each of the surfaces of the first developing sleeve 33 and the second developing sleeve 34. Further, in this embodiment, the developer carried on the first developing sleeve 33 is fed from below toward above by rotation of the first developing sleeve 33 by being regulated by the regulating member 50, so that the developer is delivered from the first developing sleeve 33 to the second developing sleeve 34.

Further, the relationship between the feeding forces C1 and C2 of the first developing sleeve 33 and the second developing sleeve 34, respectively, is made to satisfy C2/C1≥0.70. By this, in the constitution in which the developer is delivered from the first developing sleeve 33 to the second developing sleeve 34 against the gravitational direction, the occurrence of the image defect can be suppressed. That is, by setting the relationship of the feeding force comprising the groove ratio and the peripheral speed as described above, the occurrence of the drag phenomenon of the developer on the first developing sleeve 33 can be suppressed, so that the occurrence of the image defect can be suppressed. Particularly, the occurrence of the drag phenomenon can also be suppressed in the case where the process speed is increased, and therefore, it is possible to provide the image forming apparatus capable of forming the high-quality image.

### Second Embodiment

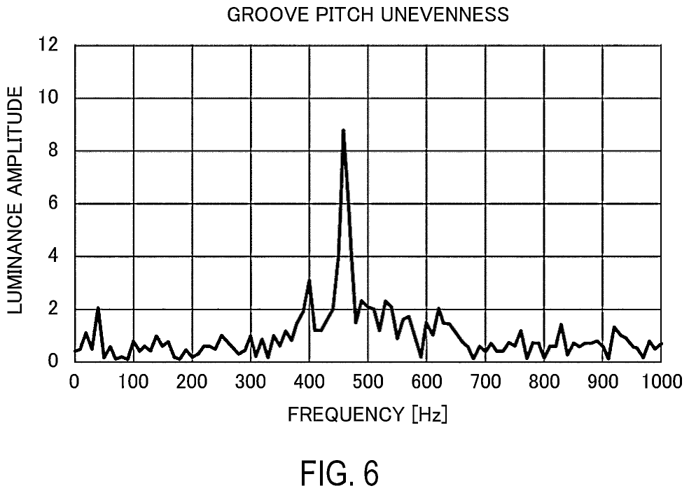

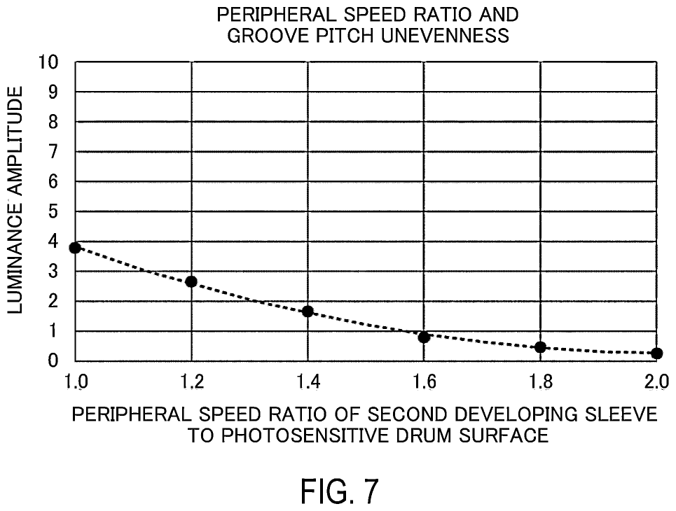

A second embodiment will be described using FIGS. 6 and 7 while making reference to FIGS. 2 and 3. In the above-described first embodiment, the uneven shape of each of the surfaces of the first developing sleeve 33 the second developing sleeve 34 is the groove shape, and the feeding force relationship therebetween was defined. In this embodiment, the peripheral speed ratio which is a parameter constituting the feeding force is further defined. Other constitutions and actions are similar to those in the above-described first embodiment, and therefore, in the following, as regards similar constitutions in the first embodiment, illustration and description are omitted or briefly made by adding the same reference numerals or symbols, a difference from the first embodiment will be principally described.

In this embodiment, in addition to the condition in the first embodiment a relationship between the peripheral speed ratio rate_v1 of the first developing sleeve 33 relative to the peripheral speed of the surface of the photosensitive drum 28Y and the peripheral speed ratio rate_v2 of the second developing sleeve 34 relative to the peripheral speed of the surface of the photosensitive drum 28Y is set to satisfy:

rate_v2>rate_v1.

Here, as a problem in the developing sleeve provided with the plurality of grooves on the surface thereof (this developing sleeve is also referred to as a grooved sleeve), there is so-called groove pitch unevenness such that pitch unevenness (non-uniformity) of a minute density difference derived from a groove interval appears in the toner image developed from the latent image on the photosensitive drum 28Y. This would be considered because a distance from the surface of the photosensitive drum 28Y is different between a groove portion and a non-groove portion and thus electric field intensity necessary for the developing step changes. In the first embodiment, the drag phenomenon which is liable to occur during formation of a solid image large in toner consumption amount was described, but the groove pitch unevenness has a feature such that the groove pitch unevenness is liable to appear in a half-tone image small in toner consumption amount than in the solid image large in toner consumption amount.

In a system including the plurality of developing sleeves, the groove pitch unevenness occurs in the upstream-side first developing sleeve 33 with respect to the rotational direction of the photosensitive drum 28Y, and then development is performed by the downstream-side second developing sleeve 34 in a state in which potential non-uniformity is grooved on the surface of the photosensitive drum 28Y. For that reason, the density non-uniformity generated in the developing step by the first developing sleeve 33 is corrected by the developing step by the second developing sleeve 34.

As measures for improving the groove pitch unevenness, there are methods in which the groove ratio of the developing sleeve surface is increased and in which the peripheral speed of the developing sleeve is increased. In the case where the groove ratio is increased, correspondingly, the developer amount of the developer carried per unit area of the developing sleeve becomes large, so that the developer is liable to clog in the opposing portion (developing nip) to the photosensitive drum 28Y. Then, another problem such that the toner image developed from the latent image on the photosensitive drum 28Y by the first developing sleeve 33 is disturbed by the developer carried on the second developing sleeve 34 or the like arises. However, the groove ratio is required to provide a size to the extent such that the condition of C2/C1 in the first embodiment is satisfied, and when the groove ratio is made excessively small, there is liability that the groove pitch unevenness due to the developing step of the second developing sleeve 34 occurs.

On the other hand, when the peripheral speed of the second developing sleeve 34 is increased, in the developing step executed in the closest portion between the second developing sleeve 34 and the photosensitive drum 28Y, the number of grooves per unit time of the grooves passing through the closest portion becomes large, so that the frequency thereof becomes high frequency at which the groove pitch unevenness of the second developing sleeve 34 itself is not readily recognized visually. Further, when the peripheral speed 34 is increased, by an increase in toner supply amount of the toner to the developing step, a change amount of the developer amount of the developer on the second developing sleeve 34 becomes small, so that the groove pitch unevenness can be effectively improved.

Next, a result of verification on the groove pitch unevenness on the second developing sleeve 34 will be described. Also, in this verification, the jig used in the verification of the first embodiment was used. Then, with respect to the closest position between the second developing sleeve 34 and the photosensitive drum 28Y, a high-speed video camera (“MEMRECAM GX-4CH”, manufactured by nac Image Technology Inc.) was installed on a side downstream of the closest position in the rotational direction of the photosensitive drum 28Y and photographed the toner image developed from the latent image. At this time, photographing was executed by changing the peripheral speed ratio of the second developing sleeve 34.

Further, the photographed image was subjected to line-image development with time with respect to a longitudinal direction in the developing nip (the closest portion between the second developing sleeve 34 and the photosensitive drum 28Y) with use of image processing software (“Image J”) and then was subjected to FFT processing, so that luminance amplitude (luminance peak value) of the frequency of the groove pitch unevenness was used as an evaluation value of the groove pitch unevenness.

In FIG. 6, a graph when the groove pitch unevenness in the case where the groove pitch unevenness was visualized by a single developing sleeve was subjected to the FFT processing and the luminance amplitude was calculated is shown as an example. In this case, a constitution in which the peripheral speed ratio rate_v1 of the first developing sleeve 33 is 1.0, the peripheral speed ratio rate_v2 of the second developing sleeve 34 is 1.2, an outer diameter of each developing sleeve was φ25 [mm], the groove ratio ρ1 of the first developing sleeve 33 is 9.1[%], and the groove ratio ρ2 of the second developing sleeve 34 is 15.2[%] was employed. Further, in this constitution, the frequency of the groove pitch unevenness measured when the half-tone image was formed on the photosensitive drum 28Y become 460 Hz.

The luminance amplitude at the above-described frequency was treated as the evaluation value of the groove pitch unevenness. Then, at this time, the luminance amplitude representing a magnitude of the groove pitch unevenness during passing through the developing steps of both the first developing sleeve 33 and the second developing sleeve 34 became 2.64. In FIG. 7, a magnitude of the luminance amplitude of the groove pitch unevenness when the peripheral speed ratio rate_v2 of the second developing sleeve 34 was changed is shown.

From FIG. 7, it was able to be confirmed that a level of the groove pitch unevenness was improved as the peripheral speed ratio rate_v2 of the second developing sleeve 34 was made large. That is, the groove pitch unevenness is not readily visible naked eyes when the luminance amplitude becomes 3.0 or less, and is almost invisible when the luminance amplitude becomes 2.0 or less. From FIG. 6, it is turned out that the luminance amplitude becomes small as the peripheral speed ratio rate_v2 of the second developing sleeve 34 is made large.

Incidentally, from FIG. 7, it is preferable to satisfy:

rate_v2≥1.2,

and it is further preferable to satisfy:

rate_v2≥1.4.

From the above, a constitution in which the peripheral speed ratio rate_v2 of the second developing sleeve 34 relative to the surface peripheral speed of the photosensitive drum 28Y is larger than the peripheral speed ratio rate_v1 of the first developing sleeve 33 relative to the surface peripheral speed of the photosensitive drum 28Y is employed, i.e., the following relationship is satisfied:

rate_v2>rate_v1.

By this, the density non-uniformity generated in the developing step by the first developing sleeve 33 is corrected in the developing step by the second developing sleeve 34, so that the groove pitch unevenness can be effectively improved. As a result, by satisfying the condition of the first embodiment, the drag phenomenon in the case where the toner consideration amount is large can be improved, and by satisfying the condition of this embodiment, the groove pitch unevenness in the case where the toner consumption amount is small can be improved, so that it is possible to provide the image forming apparatus capable of forming the high-quality image.

### Third Embodiment

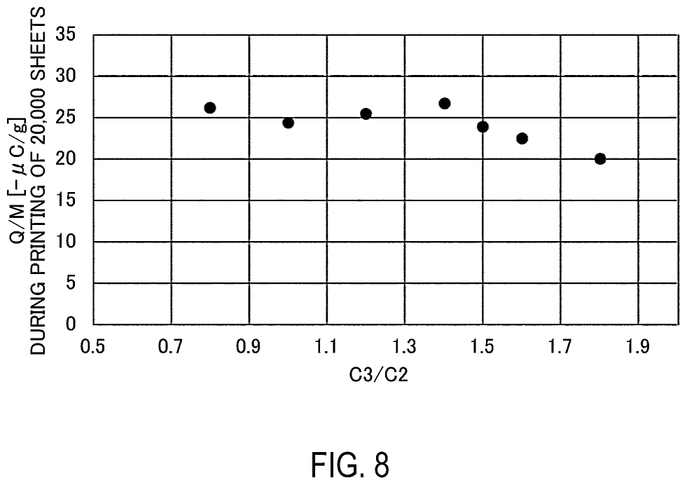

A third embodiment will be described using FIG. 8 while making reference to FIG. 2. In the above-described first and second embodiments, the uneven shape of each of the surfaces of the first developing sleeve 33 the second developing sleeve 34 is the groove shape, and the feeding force relationship therebetween was described. On the other hand, in this embodiment, a relationship between feeding forces of uneven shapes of the surfaces of the second developing sleeve 34 and the peeling sleeve 35 will be described. Other constitutions and actions are similar to those in the above-described first embodiment, and therefore, in the following, as regards similar constitutions in the first embodiment, illustration and description are omitted or briefly made by adding the same reference numerals or symbols, a difference from the first and second embodiments will be principally described.

In order to form the high-quality image by using the developing device 1Y having the above-described constitution, similarly as in the first embodiment, also when the developer is delivered from the second developing sleeve 34 to the peeling sleeve 35, it is required that there is no deliver error. When this deliver error occurs, the developer is dropped downward in the vertical direction from between the second developing sleeve 34 and the developing container 60. Then, the developer is dropped on a peeling region of the first developing magnet 36 on the first developing sleeve 33 and is supplied toward a side upstream of the regulating member 50. Then, this developer is supplied to the first developing sleeve 33 without being stirred in the developer circulation path. Further, there is also a liability that the developer is dropped from between the second developing sleeve 34 and the developing container 60 to between the first developing sleeve 33 and the second developing sleeve 34, and is fed and dragged on the second developing sleeve 34 and thus is immediately supplied to the second developing region. By this, the developer non-uniform in toner amount is subjected to the developing step, so that a fluctuation in density occurs.

The peeling sleeve 35 is disposed above the first developing sleeve 33 and adjacent to the second developing sleeve 34. In this embodiment, with respect to a horizontal line passing through the rotation center R2 of the second developing sleeve 34, the rotation center R3 of the peeling sleeve 35 is disposed above by 30 degrees. Here, a position of the rotation center R3 of the peeling sleeve 35 may preferably be above a position of the rotation sensor R2 of the second developing sleeve 34 in the vertical direction, but may be above a lower end of the second developing sleeve 34. However, the gap between the peeling sleeve 35 and the first developing sleeve 33 is required to be sufficiently ensured so that the developer is not delivered from the peeling sleeve 35 to the first developing sleeve 33. Further, the rotational direction of the peeling sleeve 35 is set to a formed direction in an opposing portion between the peeling sleeve 35 and the second developing sleeve 34 and to be rotated in the counterclockwise direction in the cross section shown in FIG. 2.

As described above, when the delivery error of the developer from the second developing sleeve 34 to the peeling sleeve 35 occurs, the drag toner is repetitively supplied to the surfaces of the first developing sleeve 33 and the second developing sleeve 34, so that the toner density becomes liable to lower and thus the density non-uniformity becomes liable to occur.

For this reason, in this embodiment, similarly as in the first embodiment, a feeding force C3 will be considered. When a peripheral speed ratio of the peeling sleeve 35 relative to the second developing sleeve 34 is rate_v3 and a groove ratio of the surface of the peeling sleeve 35 is ρ3, the feeding force C3 of the peeling sleeve 35 is represented by the following formula 5:

C3=ρ3×rate_v3 (formula 5).

Here, a function required for the peeling sleeve 35 is such that all the developer is received and collected from the second developing sleeve 34, and uniformity of a layer of the developer carried by the peeling sleeve 35 or the like is not almost required. From this, the feeding force C3 of the peeling sleeve 35 can be sufficiently made larger than the feeding force C2 of the second developing sleeve 34. For this reason, in this embodiment, it is desirable that at least the following relationship:

C3>V2

is satisfied. Further, the relationship between C3 and C2 may satisfy:

C3/C2≥1.1, or

C3/C2≥1.3.

Further, in the case where the feeding force C3 of the peeling sleeve 35 is excessively larger than the feeding force C2 of the second developing sleeve 34, in the gap of the opposing portion, where the developer is transferred, between the second developing sleeve 34 and the peeling sleeve 35, friction of the developer with each of the sleeve surfaces becomes strong. For that reason, toner deterioration such that an external additive of the toner is detached from the toner surface and is transferred onto a carrier surface or deterioration such as abrasion of the carrier surface occurs. Further, the deterioration progresses, so that the toner charge amount lowers and leads to a density fluctuation. For this reason, it is desirable that the following peripheral is satisfied:

C3/C2≤1.50.

In FIG. 8, a change in toner charge amount which is an index of the developer deterioration in the case where the image is formed by using the main assembly of the image forming apparatus 100 when the relationship of C3/C2 is changed is shown. The toner charge amount was measured as Q/M (charge amount per unit mass [−μC/g]) by using “E-SPART ANALYZER” manufactured by Hosokawa Micron Corp. Further, the image formation was carried out in a simple constitution for developer deterioration such that discharge opening of an ACR discharging mechanism for refreshing the carrier is closed and only the toner is filled as a supply developer. Further, as a condition such that the developer is liable to deteriorate, a high-temperature/high-humidity environment of 30° C. and 80% RH which is an external environment is employed, and as print images, lateral band images each extending in a main scan direction with an image area ratio of 30% (in the case where a consumption amount of A4 solid (whole surface) image is taken as 100%) were printed on 20,000 sheets (recording materials) in a state of a certain TD ratio.

As is apparent from FIG. 8, the toner charge amount after the printing has a tendency that the charge amount lowers from that in the case where C3/C2 is 1.4 or more, and there was a tendency that the toner charge amount lowers by about 20% in the case where C3/C2 is 1.8 than in the case where C3/C2 is 1.4. Thus, a relationship between the feeding force C3 of the peeling sleeve 35 and the feeding force C2 of the second developing sleeve 34 may desirably satisfy the following:

$$1. < C 3 / C 2 \leq 1.5 .$$

Further, the relationship between the feeding force C1 of the first developing sleeve 33 and the feeding force C3 of the peeling sleeve 35 may preferably satisfy at least:

$$C 3 / C 1 \geq 1. .$$

Thus, by satisfying C3/C1≥1.0, the developer amount of the developer in the developing container 60 can be maintained at an appropriately certain level. Further, when a constitution satisfying the following relationships:

$$\begin{matrix}1. < C 3 / C 2 \leq 1.5 , and \\ C 3 / C 1 \geq 1.\end{matrix}$$

is employed, a more stable operation of the developer in the developing device can be performed.

From the above, a constitution in which the feeding force C3 of the peeling sleeve 35 is larger than the feeding force C2 of the second developing sleeve 34 is employed, so that the developing of the developer on the second developing sleeve 34 can be improved, and in addition, the developer deterioration can be suppressed, so that a higher-quality image can be provided.

### OTHER EMBODIMENTS

The present invention is not limited to the constitution of the above-described embodiments. For example, the image forming apparatus 100 is not limited to the MFP, but may also be a copying machine, a printer, or a facsimile machine. Further, the constitutions of the developer supplying screw 42, the developer stirring screw 43, and the developer collecting screw 44 are not particularly limited when the constitutions can feed the developer, and for example, it is possible to apply a helical blade, a paddle-like blade.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2024-024892 filed on Feb. 21, 2024 and 2025-003864 filed on Jan. 10, 2025, which is hereby incorporated by reference herein in its entirety.

What is claimed is:

1. A developing device comprising:
a developing container configured to contain a developer including toner and a carrier;
a first rotatable developing member to which the developer contained in the developing container is supplied and which carries and feeds the developer to a first developing position where an electrostatic latent image formed on a rotatable image bearing member is developed;
a second rotatable developing member provided opposed to the first rotatable developing member and to which the developer is delivered from the first rotatable developing member, wherein the second rotatable developer member carries and feeds the developer to a second developing position where the electrostatic latent image passed through the first developing position is developed;
a first magnet provided non-rotatably and stationarily inside the first rotatable developing member; and
a second magnet provided non-rotatably and stationarily inside the second rotatable developing member,
wherein a rotational axis of the second rotatable developing member is positioned above a rotational axis of the first rotatable developing member,
wherein the developer is delivered from the first rotatable developing member to the second rotatable developing member against a gravitational direction by a magnetic field generated between the first magnet and the second magnet,
wherein on an outer peripheral surface of the first rotatable developing member, a plurality of first grooves are formed along a circumferential direction of the first rotatable developing member, and
wherein on an outer peripheral surface of the second rotatable developing member, a plurality of second groves are formed along a circumferential direction of the second rotatable developing member.

2. A developing device according to claim 1, wherein in a case where
a width of each of the first grooves is d1,
a number of the first grooves per one-full circumference of the first rotatable developing member is N1,
a peripheral length of the first rotatable developing member is L1,
a groove ratio of the first grooves is ρ1=(d1×N1)/L1,
a width of each of the second grooves is d2,
a number of the second grooves per one-full circumference of the second rotatable developing member is N2,
a peripheral length of the second rotatable developing member is L2,
a groove ratio of the second grooves is ρ2=(d2×N2)/L2,
a peripheral speed ratio of the first rotatable developing member to the image bearing member is rate_v1,
a peripheral speed ratio of the second rotatable developing member to the image bearing member is rate_v2,
a developer feeding force of the first rotatable developing member is C1=ρ1×rate_v1, and
a developer feeding force of the second rotatable developing member is C2=ρ2×rate_v2,
the following relationship is satisfied:
$$0.7 \leq C 2 / C 1 < 1.45 .$$

3. A developing device according to claim 2, wherein the following relationship is further satisfied:
$$1. < C 2 / C 1.$$

4. A developing device according to claim 2, wherein the following relationships are further satisfied:
ρ1=ρ2, and
rate_v1<rate_v2.

5. A developing device according to claim 2, wherein the following relationships are further satisfied:
ρ1<ρ2, and
rate_v1=rate_v2.

6. A developing device according to claim 1, wherein in a case where
a width of each of the first grooves is d1,
a number of the first grooves per one-full circumference of the first rotatable developing member is N1,
a peripheral length of the first rotatable developing member is L1,
a groove ratio of the first grooves is ρ1=(d1×N1)/L1,
a width of each of the second grooves is d2,
a number of the second grooves per one-full circumference of the second rotatable developing member is N2,
a peripheral length of the second rotatable developing member is L2,
a groove ratio of the second grooves is ρ2=(d2×N2)/L2,
a peripheral speed ratio of the first rotatable developing member to the image bearing member is rate_v1, and
a peripheral speed ratio of the second rotatable developing member to the image bearing member is rate_v2,
the following relationships are satisfied:
ρ1=ρ2, and
rate_v1<rate_v2.

7. A developing device according to claim 1, wherein in a case where
a width of each of the first grooves is d1,
a number of the first grooves per one-full circumference of the first rotatable developing member is N1,
a peripheral length of the first rotatable developing member is L1,
a groove ratio of the first grooves is ρ1=(d1×N1)/L1,
a width of each of the second grooves is d2,
a number of the second grooves per one-full circumference of the second rotatable developing member is N2,
a peripheral length of the second rotatable developing member is L2,
a groove ratio of the second grooves is ρ2=(d2×N2)/L2,
a peripheral speed ratio of the first rotatable developing member to the image bearing member is rate_v1, and
a peripheral speed ratio of the second rotatable developing member to the image bearing member is rate_v2,
the following relationships are satisfied:
ρ1<ρ2, and
rate_v1=rate_v2.

8. A developing device according to claim 1, wherein the first rotatable developing member and the second rotatable developing member are rotated in directions opposite to each other in a position where the first rotatable developing member and the second rotatable developing member oppose each other.

9. A developing device according to claim 8, wherein the first rotatable developing member and the image bearing member are rotated in the same direction in a position where the first rotatable developing member and the image bearing member oppose each other, and
wherein the second rotatable developing member and the image bearing member are rotated in the same direction in a position where the second rotatable developing member and the image bearing member oppose each other.
